(19) United States
(12) Patent Application Publication
(10) Pub. No.: US 2008/0123590 A1
(43) Pub. Date: May 29, 2008

(54) Apparatus and method for transmitting/receiving localized-type resource allocation information in a communication system

(75) Inventors: Young-Ho Jung, Suwon-si (KR); Cheol-Woo You, Seoul (KR); Dong-Ho Kim, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 11/998,270

(22) Filed: Nov. 29, 2007

(30) Foreign Application Priority Data
Nov. 29, 2006 (KR) 2006-118885

(51) Int. Cl. H04Q 7/00

(52) U.S. Cl. 370/329

(57) ABSTRACT

A method and apparatus for transmitting localized-type resource allocation information by a base station in a communication system. The base station transmits allocation information for localized-type resources using multiple mini-resource blocks. The mini-resource blocks are generated by dividing the localized-type resources into first localized-type resources for mini-resource block generation, and second localized-type resources, and dividing the first localized-type resources by a predetermined number.

### CROSS-REFERENCE TO RELATED APPLICATION AND CLAIM OF PRIORITY

This application claims the benefit under 35 U.S.C. §119(a) of a Korean Patent Application filed in the Korean Intellectual Property Office on Nov. 29, 2006 and assigned Serial No. 2006-118885, the disclosure of which is incorporated herein by reference

### TECHNICAL FIELD OF THE INVENTION

The present invention relates generally to an apparatus and method for transmitting and receiving resource allocation information in a communication system, and in particular, to an apparatus and method for transmitting and receiving allocation information for localized-type resources in a communication system.

### BACKGROUND OF THE INVENTION

In general, next generation communication systems are evolving into advanced systems for providing mobile stations with services capable of high-speed, high-capacity data transmission and reception. An Institute of Electrical and Electronics Engineers (IEEE) 802.16e communication system and an IEEE 802.20 communication system are typical examples of the next generation communication system.

With reference to FIG. 1, a description will now be made of an operation of transmitting resource allocation information for localized-type resources in the IEEE 802.16e communication system.

FIG. 1 schematically illustrates an operation of transmitting resource allocation information for localized-type resources in a base station (BS) of a general IEEE 802.16e communication system.

Referring to FIG. 1, a frame for the IEEE 802.16e communication system includes a downlink (DL) frame 100 and an uplink (UL) frame 150. The downlink frame 100 includes a Frame Control Header (FCH) field 111, Generic Medium Access Control (MAC) Header (GMH) fields 113-1 and 113-2, a Downlink MAP (DL-MAP) field 115, an Uplink MAP (UL-MAP) field 117, Cyclic Redundancy Check (CRC) fields 119-1 and 119-2, and downlink burst fields (i.e., downlink burst_#1 field 121-1, downlink burst_#2 field 121-2, downlink burst_#3 field 121-3, and downlink burst_#4 field 121-4). The DL-MAP field 115 includes multiple DL-MAP Information Elements (IEs) 123-1, 123-2, 123-3 and 123-4. The UL-MAP field 117 includes multiple UL-MAP IEs 125-1, 125-2, 125-3 and 125-4.

The uplink frame 150 includes a Channel Quality Information Channel (CQICH) field 151, an Acknowledgement (ACK) Channel (ACKCH) field 153, a Code Division Multiple Access (CDMA) ranging field 155, and uplink burst fields (i.e., uplink burst_#1 field 157-1, uplink burst_#2 field 157-2, and uplink burst_#3 field 157-3).

Basic information for subchannel, ranging, modulation scheme, and the like is transmitted over the FCH field 111. A DL-MAP message is transmitted over the DL-MAP field 115, and the DL-MAP message includes the DL-MAP IEs 123-1, 123-2, 123-3 and 123-4. Here, the DL-MAP IE 123-1 includes resource allocation information for the downlink burst_#1 field 121-1; the DL-MAP IE 123-2 includes resource allocation information for the downlink burst_#2 field 121-2; the DL-MAP IE 123-3 includes resource allocation information for the downlink burst_#3 field 121-3; and the DL-MAP IE 123-4 includes resource allocation information for the downlink burst_#4 field 121-4. The downlink burst_#1 field 121-1 through the downlink burst_#4 field 121-4 are used for transmitting corresponding downlink data bursts.

Similarly, a UL-MAP message is transmitted over the UL-MAP field 117, and the UL-MAP message includes multiple UL-MAP IEs 125-1, 125-2, 125-3 and 125-4. Here, UL-MAP IE 125-1 includes resource allocation information for the uplink burst_#1 field 157-1; the UL-MAP IE 125-2 includes resource allocation information for the uplink burst_#2 field 157-2; and the UL-MAP IE 125-3 includes resource allocation information for the uplink burst_#3 field 157-3. The uplink burst_#1 field 157-1 through the uplink burst_#3 field 157-3 are used for transmitting corresponding uplink data bursts.

A CQICH signal is transmitted over the CQICH field 151, and an ACKCH signal is transmitted over the ACKCH field 153. A ranging code is transmitted over the CDMA ranging field 155.

As shown in FIG. 1, the downlink frame 100 supports the distributed-type resource configuration and the localized-type resource configuration. That is, the FCH field 111, the GMH fields 113-1 and 113-2, the DL-MAP field 115, the UL-MAP field 117, the CRC fields 119-1 and 119-2, the downlink burst_#1 field 121-1, and the downlink burst_#2 field 121-2 use distributed-type resources, while the downlink burst_#3 field 121-3 and the downlink burst_#4 field 121-4 use localized-type resources.

As described in FIG. 1, the base station (BS) of the IEEE 802.16e communication system transmits resource allocation information for the downlink bursts over the DL-MAP field 115, and transmits resource allocation information for the uplink bursts over the UL-MAP field 117. However, as shown in FIG. 1, positions of the DL-MAP field 115 and the UL-MAP field 117, over which the resource allocation information is transmitted, are set as a start point of the downlink frame 100. Therefore, a period, for which the resource allocation information is transmitted, increases in units of frames, causing an increase in the delay for transmitting the resource allocation information in the IEEE 802.16e communication system using Hybrid Automatic Repeat reQuest (HARQ). Further, because the DL-MAP field 115 and the UL-MAP field 117 necessarily use only the distributed-type resources as described in FIG. 1, when there is no distributed-type resource available in the IEEE 802.16e communication system, the base station (BS) can no longer transmit the resource allocation information.

Next, with reference to FIG. 2, a description will be made of an operation of transmitting resource allocation information for localized-type resources in a base station of a general IEEE 802.20 communication system.

FIG. 2 schematically illustrates an operation of transmitting resource allocation information for localized-type resources in a BS of a general IEEE 802.20 communication system.

Referring to FIG. 2, a Forward Link Physical (FL PHY) layer frame of the IEEE 802.20 communication system includes a Forward Shared Signaling Channel (F-SSCH) field 200, and Forward Data Channel (F-DCH) fields (i.e., F-DCH #1 220-1, F-DCH #2 220-2 and F-DCH #3 220-3). The F-SSCH field 200, a field for transmitting a control signal, includes Forward Link Assignment Blocks (FLABs) 200-1, 200-2 and 200-3; CRCs 202-1, 202-2 and 202-3 associated with the FLABs 200-1, 200-2 and 200-3, respectively; Reverse Link Assignment Blocks (RLABs) 210-1 and 210-2; and CRCs 212-1 and 212-2 associated with the RLABs 210-1 and 210-2, respectively. Here, the FLABs 200-1, 200-2 and 200-3 include resource allocation information for the F-DCH #1 220-1, the F-DCH #2 220-2 and the F-DCH #3 220-3, respectively. The RLABs 210-1 and 210-2, though not separately shown in FIG. 2, include resource allocation information for Reverse Data Channels (R-DCHs) included in a Reverse Link Physical (RL PHY) layer frame of the IEEE 802.20 communication system, respectively.

As shown in FIG. 2, the FL PHY layer frame of the IEEE 802.20 communication system occupies an 8-Orthogonal Frequency Division Multiplexing (OFDM) symbol interval (i.e., occupies a 0.91-ms interval) in the time domain and occupies a 512-tone interval (i.e., a 5-MHz interval) in the frequency domain. In addition, F-DCH signals are transmitted over the F-DCH #1 220-1, the F-DCH #2 220-2 and the F-DCH #3 220-3.

The FL PHY layer frame described in FIG. 2 supports only the localized-type resource configuration. Therefore, as shown in FIG. 2, the base station of the IEEE 802.20 communication system transmits resource allocation information for the localized-type resources using the localized-type resources. That is, the base station of the IEEE 802.20 communication system transmits resource allocation information for the F-DCH #1 220-1, the F-DCH #2 220-2 and the F-DCH #3 220-3, which are localized-type resources, over the FLABs 202-1, 202-2 and 202-3, which are transmitted using localized-type resources, respectively. When a channel gain of the frequency field, or F-SSCH field 200, over which the resource allocation information is transmitted, is low, reliability of the resource allocation information considerably reduces.

### SUMMARY OF THE INVENTION

To address the above-discussed deficiencies of the prior art, it is a primary aspect of the present invention to address at least the problems and/or disadvantages and to provide at least the advantages described below. Accordingly, an aspect of the present invention is to provide an apparatus and method for transmitting/receiving allocation information for localized-type resources in a communication system.

According to one aspect of the present invention, there is provided an apparatus for transmitting localized-type resource allocation information in a communication system. The apparatus includes a base station for transmitting allocation information for localized-type resources using multiple mini-resource blocks; wherein the mini-resource blocks are generated by dividing the localized-type resources into first localized-type resources for mini-resource block generation, and second localized-type resources, and dividing the first localized-type resources by a predetermined number.

According to another aspect of the present invention, there is provided an apparatus for receiving localized-type resource allocation information in a communication system. The apparatus includes a mobile station for receiving allocation information for localized-type resources over multiple mini-resource blocks; wherein the mini-resource blocks are generated by dividing the localized-type resources into first localized-type resources for mini-resource block generation, and second localized-type resources, and dividing the first localized-type resources by a predetermined number.

According to further another aspect of the present invention, there is provided a method for transmitting localized-type resource allocation information by a base station in a communication system. The method includes transmitting allocation information for localized-type resources using multiple mini-resource blocks; wherein the mini-resource blocks are generated by dividing the localized-type resources into first localized-type resources for mini-resource block generation, and second localized-type resources, and dividing the first localized-type resources by a predetermined number.

According to yet another aspect of the present invention, there is provided a method for receiving localized-type resource allocation information by a mobile station in a communication system. The method includes receiving allocation information for localized-type resources over multiple mini-resource blocks; wherein the mini-resource blocks are generated by dividing the localized-type resources into first localized-type resources for mini-resource block generation, and second localized-type resources, and dividing the first localized-type resources by a predetermined number.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 schematically illustrates an operation of transmitting resource allocation information for localized-type resources in a base station of a general IEEE 802.16e communication system;

FIG. 2 schematically illustrates an operation of transmitting resource allocation information for localized-type resources in a base station of a general IEEE 802.20 communication system;

FIG. 3 illustrates mini-resource block structure according to an embodiment of the present invention; and

FIG. 4 schematically illustrates an operation of transmitting localized-type resource allocation information using mini-blocks according to an embodiment of the present invention.

### DETAILED DESCRIPTION OF THE INVENTION

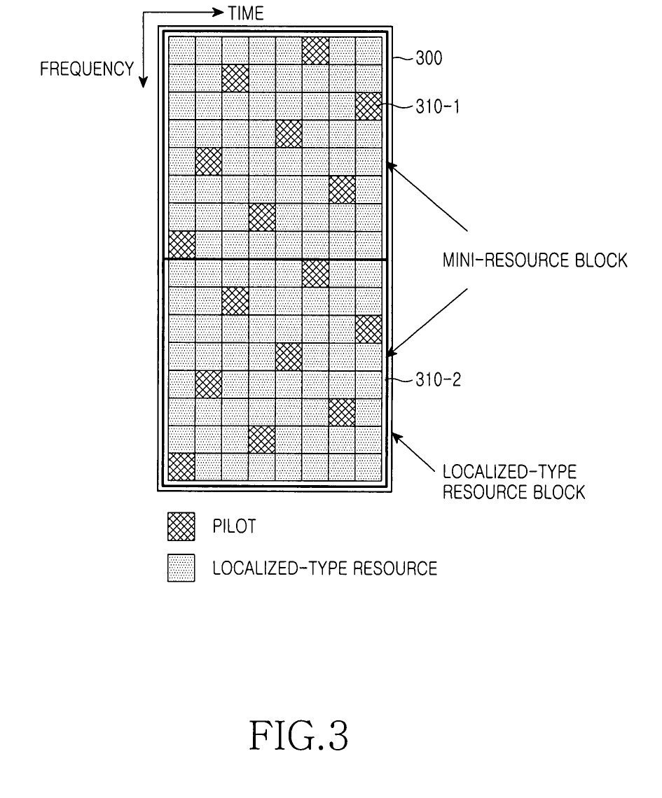

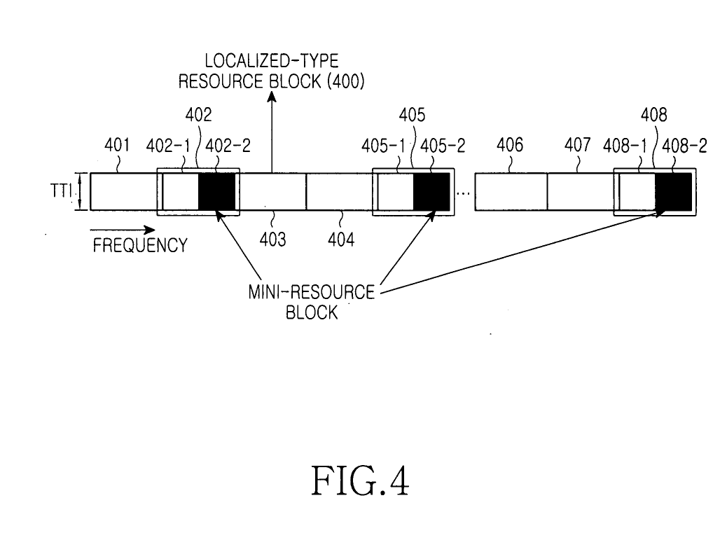

FIGS. 3 and 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication systems.

The present invention provides an apparatus and method for transmitting and receiving allocation information for localized-type resources in a communication system. The term “localized-type resource” as used herein means a basic resource allocation unit composed of concatenated subcarriers.

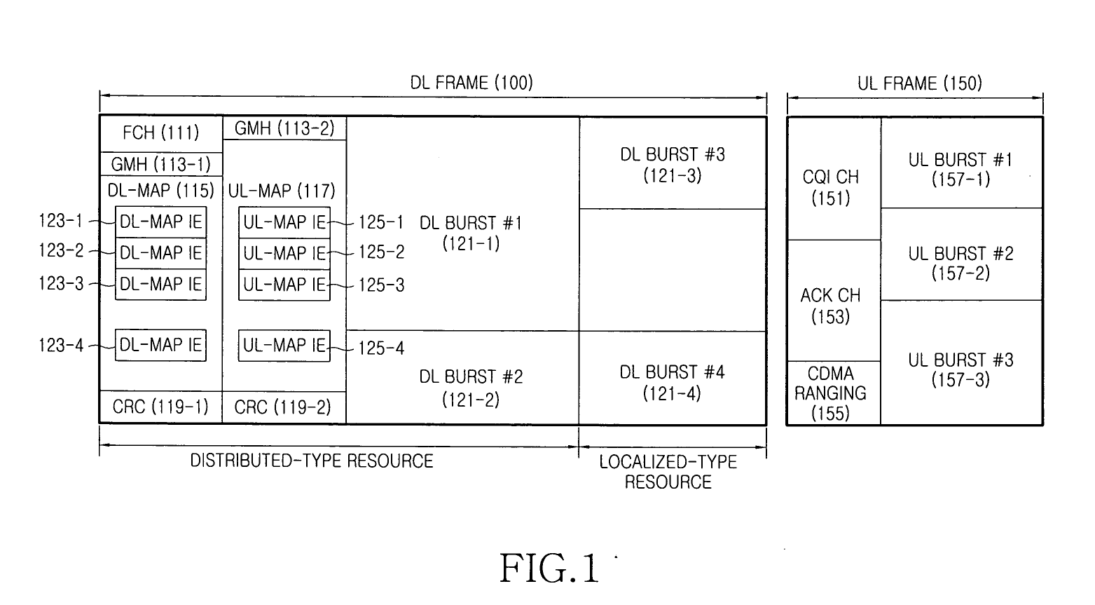

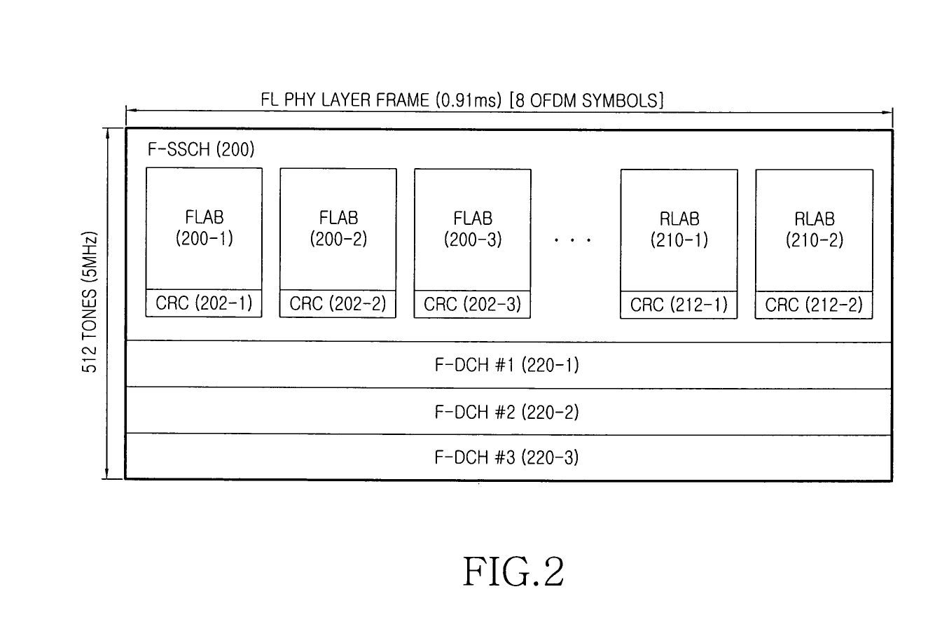

An Institute of Electrical and Electronics Engineers (IEEE) 802.16e communication system and an IEEE 802.20 communication system are typical examples of the next generation communication system, and an operation of transmitting and receiving allocation information for localized-type resources in the IEEE 802.16e communication system and the IEEE 802.20 communication system has been described with reference to FIGS. 1 and 2. As described above, when the base station of the IEEE 802.16e communication system transmits allocation information for the localized-type resources, positions of the fields, or downlink MAP (DL-MAP) field and uplink MAP (UL-MAP) field, over which the resource allocation information for the localized-type resources is transmitted are allocated as a start point of the downlink frame. As a result, an IEEE 802.16e communication system using Hybrid Automatic Repeat reQuest (HARQ) increases the delay for transmitting the resource allocation information, and uses only the distributed-type resources. Therefore, when there is no available distributed-type resource, the IEEE 802.16e communication system can no longer transmit the resource allocation information. In addition, in the case where the base station of the IEEE 802.20 communication system transmits information on the localized-type resources, when a channel gain of the frequency field, or Forward Shared Signaling Channel (F-SSCH) field, over which the resource allocation information for the localized-type resources is transmitted, is low, reliability of the localized-type resource allocation information considerably reduces.

Therefore, the present invention provides an apparatus and method for transmitting and receiving localized-type resource allocation information in a base station of a communication system using mini-resource blocks.

With reference to FIG. 3, a description will now be made of a mini-resource block structure according to an embodiment of the present invention.

FIG. 3 illustrates mini-resource block structure according to an embodiment of the present invention.

Before a description of FIG. 3 is given, it should be noted that a base station (BS) divides its available localized-type resources into first localized-type resources for mini-resource block generation, and second localized-type resources which are the remaining localized-type resources. Further, the base station divides the first localized-type resources into a predetermined number of, for example, N mini-blocks. The number of mini-resource blocks generated or divided from the first localized-type resources and a ratio of the first localized-type resources to the second localized-type resources among all the localized-type resources are adaptively determined according to the conditions of the communication system and the size of the resource allocation information.

Further, a description will be made of the reason for generating the mini-blocks.

The mini-resource blocks are used to maintain the reliability of allocation information for the localized-type resources using the localized-type resources, and to prevent the delay from occurring even when the BS transmits localized-type resource allocation information by HARQ. That is, the BS encodes the localized-type resource allocation information with one channel encoding block, and transmits the encoded allocation information using multiple mini-resource blocks, making it possible to obtain the maximum frequency diversity gain in the frequency domain even with the use of the mini-resource blocks which are localized-type resources.

Referring to FIG. 3, first localized-type resources for mini-resource block generation among the localized-type resources available in the BS are denoted as a localized-type resource block 300. For convenience, in FIG. 3, the first localized-type resources will referred to as a localized-type resource block 300. The localized-type resource block 300 occupies an interval of a plurality of, for example, 8 Orthogonal Frequency Division Multiplexing (OFDM) symbols in the time domain, and occupies a plurality of, for example, 16 subcarriers in the frequency domain.

The localized-type resource block 300 includes N (e.g., N=2) mini-resource blocks 310-1 and 310-2. As shown in FIG. 3, the mini-resource blocks 310-1 and 310-2 each include multiple pilot fields, and pilot signals are transmitted over the pilot fields. Positions and the number of the pilot fields can adaptively vary according to the conditions of the communication system.

As a result, the BS encodes the allocation information for the localized-type resources with one channel encoding block, and then transmits the encoded allocation information using multiple mini-resource blocks. In this case, because the multiple mini-resource blocks, even though they are localized-type resources, are used for transmitting the localized-type resource allocation information, the frequency diversity gain can be obtained. If positions of the mini-resource blocks in the first localized-type resources over which the localized-type resource allocation information is transmitted are fixedly determined, there is no need to separately transmit information on the positions. However, the proposed system, unlike the 802.16 system, can transmit the resource allocation information every resource transmission period, causing a decrease in the resource allocation period. Therefore, no delay occurs even though the localized-type resource allocation information is transmitted by HARQ.

With reference to FIG. 4, a description will now be made of an operation of transmitting localized-type resource allocation information using mini-blocks according to an embodiment of the present invention.

FIG. 4 schematically illustrates an operation of transmitting localized-type resource allocation information using mini-blocks according to an embodiment of the present invention.

Referring to FIG. 4, a BS allocates localized-type resources including some parts 402, 405 and 408 of a localized-type resource block 400 as first localized-type resources, divides each first localized-type resource into two mini-resource blocks, and uses the right-sided mini-resource blocks 402-2, 405-2 and 408-2 among the mini-resource blocks constituting each localized-type resource, for resource allocation information transmission. Although a description of FIG. 4 has been made for the exemplary case where the right-sided mini-resource blocks are used for resource allocation information transmission regardless of the localized-type resources, the mini-resource blocks used for resource allocation information transmission are subject to change for each localized-type resource based on the rule previously agreed upon between the base station (BS) and the mobile station (MS). The resource allocation information is encoded with one channel encoding block, and then transmitted over multiple mini-resource blocks uniformly distributed in the frequency domain as shown in FIG. 4. As a result, the frequency diversity gain can be obtained and the resource allocation information transmission is available every resource transmission period, making it possible to minimize the delay even though HARQ is used for transmission of the localized-type resource allocation information.

Although an operation of receiving the localized-type resource allocation information is not separately shown in FIGS. 3 and 4, if orders of localized-type resources associated with first localized-type resources and positions of mini-blocks, both of which are defined according to the increase in the size of a resource allocation message, are previously agreed upon between the BS and the MS, and the size information of the resource allocation message is transmitted over a separate broadcasting channel, the MS can receive position information of the mini-block, over which resource allocation information is transmitted, for the corresponding resource allocation period, without separate information transmission for each mini-block position.

In addition, when the first localized-type resources are allocated to a particular mobile station in a data resource allocation process, the mobile station, as it recognizes that some of the corresponding localized-type resources are used for resource allocation information transmission, can perceive that the remaining physical resources except for the mini-blocks used for resource allocation information transmission among the corresponding localized-type resources are allocated for data transmission, even though only the localized-type resource index information other than the mini-block index information is provided. That is, in the exemplary case of FIG. 4, when the resource 402 is allocated to a particular MS for data transmission, the MS can automatically realize that the mini-block resource 402-1 is allocated, even though the BS provides the MS with information indicating the allocation of the resource 402 without providing explicit information indicating the allocation of the resource 402-1. Therefore, even the use of the mini-block resources is equal to the nonuse of the mini-block resources in terms of the overhead size needed for resource indexing.

As is apparent from the foregoing description, according to the present invention, the communication system transmits allocation information for the localized-type resources using multiple mini-blocks, thereby obtaining frequency diversity gain and minimizing the delay time even though HARQ is used for transmission of the localized-type resource allocation information.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting localized-type resource allocation information by a base station in a communication system, the method comprising:
transmitting allocation information for localized-type resources using multiple mini-resource blocks;
wherein the mini-resource blocks are generated by dividing the localized-type resources into first localized-type resources for mini-resource block generation, and second localized-type resources, and dividing the first localized-type resources by a predetermined number.

2. The method of claim 1, wherein a ratio of a number of pilot transmission resources to a number of data transmission resources in the mini-block is identical regardless of the mini-block.

3. The method of claim 1, wherein the first localized-type resources occupy an interval of a predetermined number of Orthogonal Frequency Division Multiplexing (OFDM) symbols in a time domain, and occupy an interval of a predetermined number of subcarrier fields in a frequency domain.

4. The method of claim 1, wherein orders of localized-type resources allocated to the first localized-type resources follow the orders predetermined according to an allocation ratio of the first localized-type resources to the second localized-type resources.

5. The method of claim 1, wherein mini-blocks used for resource allocation information transmission among the mini-blocks constituting the first localized-type resources are predetermined for each localized-type resource.

6. The method of claim 1, further comprising:
encoding the allocation information for first localized-type resources with one channel encoding block, and transmitting the encoded allocation information using all mini-blocks used for resource allocation information transmission among the mini-blocks constituting the first localized-type resources.

7. The method of claim 4, wherein the orders of localized-type resources allocated to the first localized-type resources are uniformly distributed in a frequency domain to obtain sufficient frequency diversity.

8. The method of claim 1, further comprising:
when the first localized-type resources are used for data transmission, providing localized-type resource index information other than mini-block resource index information during transmission of resource allocation information for corresponding data transmission.

9. An apparatus for transmitting localized-type resource allocation information in a communication system, the apparatus comprising:
a base station for transmitting allocation information for localized-type resources using multiple mini-resource blocks;
wherein the mini-resource blocks are generated by dividing the localized-type resources into first localized-type resources for mini-resource block generation, and second localized-type resources, and dividing the first localized-type resources by a predetermined number.

10. The apparatus of claim 9, wherein a ratio of a number of pilot transmission resources to a number of data transmission resources in the mini-block is identical regardless of the mini-block.

11. The apparatus of claim 9, wherein the first localized-type resources occupy an interval of a predetermined number of Orthogonal Frequency Division Multiplexing (OFDM) symbols in a time domain, and occupy an interval of a predetermined number of subcarrier fields in a frequency domain.

12. The apparatus of claim 9, wherein orders of localized-type resources allocated to the first localized-type resources follow the orders predetermined according to an allocation ratio of the first localized-type resources to the second localized-type resources.

13. The apparatus of claim 9, wherein mini-blocks used for resource allocation information transmission among the mini-blocks constituting the first localized-type resources are predetermined for each localized-type resource.

14. The apparatus of claim 9, wherein the base station encodes the allocation information for first localized-type resources with one channel encoding block, and transmits the encoded allocation information using all mini-blocks used for resource allocation information transmission among the mini-blocks constituting the first localized-type resources.

15. The apparatus of claim 12, wherein the orders of localized-type resources allocated to the first localized-type resources are uniformly distributed in a frequency domain to obtain sufficient frequency diversity.

16. The apparatus of claim 9, wherein when the first localized-type resources are used for data transmission, the BS provides localized-type resource index information other than mini-block resource index information during transmission of resource allocation information for corresponding data transmission.

17. A method for receiving localized-type resource allocation information by a mobile station in a communication system, the method comprising:
receiving allocation information for localized-type resources over multiple mini-resource blocks;
wherein the mini-resource blocks are generated by dividing the localized-type resources into first localized-type resources for mini-resource block generation, and second localized-type resources, and dividing the first localized-type resources by a predetermined number.

18. The method of claim 17, wherein a ratio of a number of pilot transmission resources to a number of data transmission resources in the mini-block is identical regardless of the mini-block.

19. The method of claim 17, wherein the first localized-type resources occupy an interval of a predetermined number of Orthogonal Frequency Division Multiplexing (OFDM) symbols in a time domain, and occupy an interval of a predetermined number of subcarrier fields in a frequency domain.

20. The method of claim 17, wherein orders of localized-type resources allocated to the first localized-type resources follow the orders predetermined according to an allocation ratio of the first localized-type resources to the second localized-type resources.

21. The method of claim 17, wherein mini-blocks used for resource allocation information transmission among the mini-blocks constituting the first localized-type resources are predetermined for each localized-type resource.

22. The method of claim 17, wherein the allocation information for first localized-type resources is encoded with one channel encoding block, and the encoded allocation information is transmitted using all mini-blocks used for resource allocation information transmission among the mini-blocks constituting the first localized-type resources.

23. The method of claim 20, wherein the orders of localized-type resources allocated to the first localized-type resources are uniformly distributed in a frequency domain to obtain sufficient frequency diversity.

24. The method of claim 17, wherein when the first localized-type resources are used for data transmission, localized-type resource index information other than mini-block resource index information is provided during transmission of resource allocation information for corresponding data transmission.

25. An apparatus for receiving localized-type resource allocation information in a communication system, the apparatus comprising:
a mobile station for receiving allocation information for localized-type resources over multiple mini-resource blocks;
wherein the mini-resource blocks are generated by dividing the localized-type resources into first localized-type resources for mini-resource block generation, and second localized-type resources, and dividing the first localized-type resources by a predetermined number.

26. The apparatus of claim 25, wherein a ratio of a number of pilot transmission resources to a number of data transmission resources in the mini-block is identical regardless of the mini-block.

27. The apparatus of claim 25, wherein the first localized-type resources occupy an interval of a predetermined number of Orthogonal Frequency Division Multiplexing (OFDM) symbols in a time domain, and occupy an interval of a predetermined number of subcarrier fields in a frequency domain.

28. The apparatus of claim 25, wherein orders of localized-type resources allocated to the first localized-type resources follow the orders predetermined according to an allocation ratio of the first localized-type resources to the second localized-type resources.

29. The apparatus of claim 25, wherein mini-blocks used for resource allocation information transmission among the mini-blocks constituting the first localized-type resources are predetermined for each localized-type resource.

30. The apparatus of claim 25, wherein the allocation information for first localized-type resources is encoded with one channel encoding block, and the encoded allocation information is transmitted using all mini-blocks used for resource allocation information transmission among the mini-blocks constituting the first localized-type resources.

31. The apparatus of claim 28, wherein the orders of localized-type resources allocated to the first localized-type resources are uniformly distributed in a frequency domain to obtain sufficient frequency diversity.

32. The apparatus of claim 25, wherein when the first localized-type resources are used for data transmission, the mobile station is provided with localized-type resource index information other than mini-block resource index information during transmission of resource allocation information for corresponding data transmission.
